(19) United States
(12) Patent Application Publication
(10) Pub. No.: US 2014/0294599 A1
(43) Pub. Date: Oct. 2, 2014

(54) PUMP MOTOR CONTROL SYSTEM FOR AUTOMATIC TRANSMISSION AND METHOD THEREOF

(71) Applicant: Hyundai Motor Company, Seoul (KR)

(72) Inventors: Taehwan Wi, Bucheon-Si (KR); Jin Young Hwang, Busan (KR); Se Hwan Jo, Bucheon-si (KR)

(73) Assignee: Hyundai Motor Company, Seoul (KR)

(21) Appl. No.: 14/098,524

(22) Filed: Dec. 5, 2013

(30) Foreign Application Priority Data
Apr. 1, 2013 (KR) 10-2013-0035363

(51) Int. Cl. F16H 61/4008

(52) U.S. Cl. CPC F16H 61/4008
USPC 417/2; 417/44.2; 417/18; 417/22

(57) ABSTRACT

A pump motor control system provides for a low-pressure hydraulic pump and a high-pressure hydraulic pump on one shaft of a pump motor. A method includes detecting information including engine speed, a shift range selected, a rotation speed of the pump motor, and hydraulic pressure in a high-pressure part, controlling the rotation speed of the pump motor to be the same as the engine speed, when engine is turned on and the P range or the N range is selected by the shift lever, generating hydraulic pressure for operating a friction element in the high-pressure part by increasing the rotation speed of the pump motor, when the shift lever is moved to the D range or R range, and keeping the hydraulic pressure in the high-pressure part stable, by controlling the rotation speed of the pump motor in accordance with the hydraulic pressure at the high-pressure part.

### CROSS-REFERENCE TO RELATED APPLICATION

The present application claims priority of Korean Patent Application Number 10-2013-0035363 filed on Apr. 1, 2013, the entire contents of which application are incorporated herein for all purposes by this reference.

### BACKGROUND OF INVENTION

1. Field of Invention

The present invention relates to a pump motor control system for an automatic transmission and a method thereof. More particularly, the present invention relates to a pump motor control system for an automatic transmission which allows stable oil supply by controlling the rotation speed of a pump motor at an optimum level in accordance with hydraulic discharge pressure at a high-pressure part in a hydraulic pressure supply system of an automatic transmission equipped with two hydraulic pumps, and a method thereof.

2. Description of Related Art

As continuously required to improve the fuel efficiency of vehicles with the increase in global oil prices and to develop environmentally-friendly vehicles under the regulation of exhaust gas in each country, the vehicle manufacturers have devoted their effort to develop a technology of saving fuel in order to satisfy the demands. For the automatic transmissions, it is the most important matter for improving fuel efficiency to minimize unnecessary loss of power of the hydraulic pump.

In general, mechanical hydraulic pumps that are connected with the driving shaft of an engine and keep operating with starting of the engine are used for the hydraulic pump of the automatic transmissions, but the operation of the mechanical hydraulic pumps acts as load on the engine and causes continuous loss of power, such that it may cause a decrease in fuel efficiency.

In particular, the mechanical hydraulic pump connected to the driving shaft of an engine supplies too much oil to the low-pressure part that requires lubrication and the high-pressure part that operates a friction element, when the engine operates in the high-RPM section, such that power is unnecessarily wasted.

Recently, vehicles are equipped with an ISG (Idle Stop & Go) which stops the engine for improving fuel efficiency, when the vehicles are stopped, and are additionally equipped with an electric hydraulic pump for supplying hydraulic pressure to the automatic transmission under a restart condition after the stop.

Further, structures that supply oil to a transmission only with an electric hydraulic pump without a mechanical hydraulic pump that is connected with the driving shaft of an engine and causes a decrease in fuel efficiency by generating continuous loss of power have been developed and it is expected that automatic transmissions will be equipped only an electric hydraulic pump in the future.

The electric hydraulic pump, which is driven by a pump motor, is composed of a low-pressure hydraulic pump and a high-pressure hydraulic pump, such that the hydraulic pressure from the low-pressure hydraulic pump is supplied to low-pressure parts (e.g., a torque converter) in an automatic transmission for lubricating and cooling, while the hydraulic pressure from the high-pressure hydraulic pump is supplied to high-pressure parts in the automatic transmission so that friction elements (on-coming elements and off-going elements) can be operated.

The operations of the low-pressure hydraulic pump and the high-pressure hydraulic pump are controlled on the basis of the hydraulic pressure at the low-pressure parts and only some of the hydraulic pressure is supplied as high pressure that the high-pressure parts require.

In this configuration, in order to supply the hydraulic pressure for the low-pressure parts and the high-pressure parts, hydraulic pressure sensors are disposed at the discharge port of the low-pressure hydraulic pump and the discharge port of the high-pressure hydraulic pump and the rotation speed of the motor is controlled on the basis of the hydraulic pressure detected by the hydraulic pressure sensors.

However, since several hydraulic pressure sensors are used to control the rotation speed of the motor, the manufacturing cost may be increased with reduction of productivity and an increase in the number of parts.

Further, since the hydraulic pressure sensors detect only whether the desired pressure is reached, without detecting the extra flow rate in the channels of the low-pressure parts and the high-pressure parts, it is difficult to control the motor at the optimized rotation speed.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Various aspects of the present invention have been made in an effort to provide pump motor control system and method for an automatic transmission having advantages of stably supplying hydraulic pressure of low-pressure parts and high-pressure parts by controlling the rotation speed of a pump motor at the optimum level in accordance with hydraulic discharge pressure at high-pressure parts in a hydraulic pressure supply system of an automatic transmission equipped with a high-pressure hydraulic pump and a low-pressure hydraulic pump connected the shaft of one pump motor.

Further, the present invention keeps the rotation speed of a pump motor optimally controlled, by estimating necessary hydraulic pressure at a low-pressure part and a high-pressure part in an automatic transmission oil supply system having a structure in which a high-pressure hydraulic pressure and a low-pressure hydraulic pressure are connected to one pump motor shaft.

One aspect of the present invention provides a pump motor control system for an automatic transmission that may include a low-pressure hydraulic pump supplying hydraulic pressure to a low-pressure part in the automatic transmission, a high-pressure hydraulic pump supplying hydraulic pressure to a high-pressure part in the automatic transmission, a pump motor connecting the low-pressure hydraulic pump and the high-pressure hydraulic pump to one shaft and driving the pumps, a pump motor rotation speed detector detecting a rotation speed of the pump motor, and a shift controller controlling operation of the automatic transmission.

The shift controller may control the rotation speed of the pump motor to be the same as engine speed at the P range or the N range, generate the hydraulic pressure at the high-pressure part by increasing the rotation speed of the pump motor when the D range or R range is selected, and stabilize the hydraulic pressure by controlling the rotation speed of the pump motor in accordance with the hydraulic pressure generated at the high-pressure part.

The system may further include a hydraulic pressure sensor disposed in a hydraulic line of the high-pressure part and detecting the hydraulic pressure generated at the high-pressure part. The shift controller may compensates for the rotation speed of the pump motor by using a map set in accordance with oil temperature and durability of the automatic transmission.

Another aspect of the present invention provides a pump motor control system for an automatic transmission that may include a pump motor connecting on one shaft a low-pressure hydraulic pump supplying hydraulic pressure to a low-pressure part and a high-pressure hydraulic pump supplying hydraulic pressure to a high-pressure part in the automatic transmission, and driving the pumps, a high-pressure regulator valve controlling the hydraulic pressure generated at the high-pressure part, a low-pressure regulator valve controlling the hydraulic pressure generated at the low-pressure part, a shift controller controlling the pump motor, the high-pressure regulator valve, and the low-pressure regulator valve, and a pressure sensor disposed in a channel of the high-pressure part and detecting the hydraulic pressure generated at the high-pressure part, wherein the shift controller keeps the hydraulic pressure of the high-pressure part stable by controlling a rotation speed of the pump motor in accordance with the hydraulic pressure at the high-pressure part detected by the pressure sensor.

The shift controller may control the rotation speed of the pump motor to be the same as the engine speed at the P range or the N range. The shift controller may compensate for the rotation speed of the pump motor in accordance with the oil temperature condition and the durability of the automatic transmission.

The high-pressure regulator valve may be controlled by control pressure of a solenoid valve and an elastic force of an elastic member, and the high-pressure regulator valve may control the hydraulic pressure of a high-pressure channel. The low-pressure regulator valve may control hydraulic pressure of a low-pressure channel by recirculating hydraulic pressure in accordance with an elastic force of an elastic member and the hydraulic pressure of the low-pressure channel, which are exerted at opposite sides of the low-pressure regulator valve.

Various other aspects of the present invention provide a pump motor control method for an automatic transmission driving a low-pressure hydraulic pump and a high-pressure hydraulic pump with one shaft. The method may include detecting information including engine speed, a shift range selected by a shift lever, a rotation speed of the pump motor, and hydraulic pressure in a high-pressure part, controlling the rotation speed of the pump motor to be the same as the engine speed, when engine is turned on and the P range or the N range is selected by the shift lever, generating hydraulic pressure for operating a friction element in the high-pressure part by increasing the rotation speed of the pump motor, when the shift lever is moved to the D range or R range, and keeping the hydraulic pressure in the high-pressure part stable, by controlling the rotation speed of the pump motor in accordance with the hydraulic pressure in the high-pressure part. The rotation speed of the pump motor generating line pressure in the high-pressure part may be corrected in accordance with an oil temperature condition and durability of the automatic transmission

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a block diagram schematically illustrating a pump motor control system for an automatic transmission according to the present invention.

FIG. 2 is a schematic diagram of a hydraulic pressure supply system of an automatic transmission according to the present invention.

FIG. 3 is a flowchart illustrating a process of controlling a pump motor control for an automatic transmission according to the present invention.

FIGS. 4 and 5 are diagrams showing rotation speed control maps of a pump motor in relation to temperature and durability in controlling of a pump motor for an automatic transmission according to the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

The unrelated parts to the description of the illustrated embodiments are not shown to make the description clear and like reference numerals designate like element throughout the specification. The configurations are optionally shown in the drawings for the convenience of description and the present invention is not limited to the drawings. Using the terms of the first and the second etc. is for discriminating the components having the same name and they are not limited to the order.

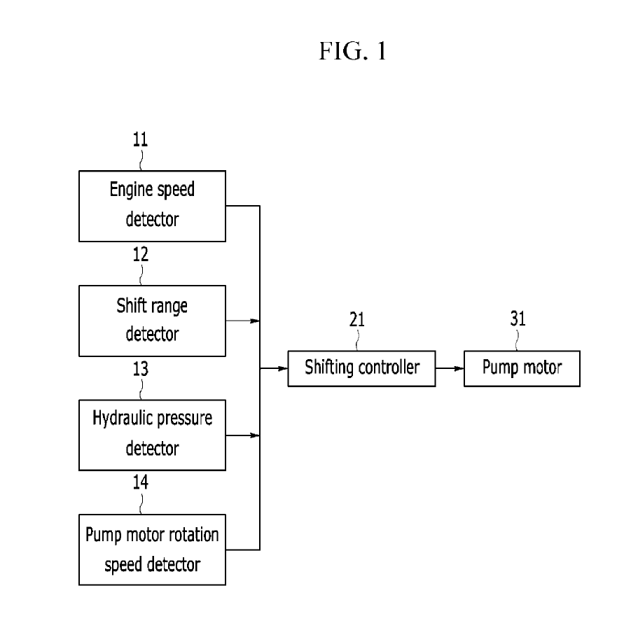

FIG. 1 is a block diagram schematically illustrating a pump motor control system for an automatic transmission according to various embodiments of the present invention. Referring to FIG. 1, the present invention includes an engine speed detector 11, a shift range detector 12, a hydraulic pressure detector 13, a pump motor rotation speed detector 14, a shift controller 21, and a pump motor 31.

The engine speed detector 11 detects the current engine speed form the rotation speed of a crankshaft or the rotation speed of a camshaft when the engine is in operation and provides the information of the engine speed to the shift controller 21.

The shift range detector 12 detects the shift ranges such as P, R, N, and D selected by a shift lever and provides the information on the ranges to the shift controller 21. The shift range detector 12 may be implemented by an inhibitor switch.

The hydraulic pressure detector 13, a hydraulic pressure sensor, detects hydraulic pressure from a high-pressure part and provides the information on the hydraulic pressure to the shift controller 21. The hydraulic pressure detector 13 may be disposed only at the high-pressure part, not the low-pressure part.

The pump motor rotation speed detector 14 detects the rotation speed of the pump motor 31 connecting a low-pressure hydraulic pump and a high-pressure hydraulic pump to one shaft and driving them and provides the information on the rotation speed to the shift controller 21.

The shift controller 21 controls the rotation speed of the pump motor 31 to be the same as the engine speed, when the shift range selected by the shift lever is the P range or the N range, with the engine on. The shift controller 21 makes line pressure be generated in the high-pressure part by increasing the rotation speed of the pump motor 31, when the shift lever is moved to the D range with the rotation speed of the pump motor 31 controlled to be the same as the engine speed.

Accordingly, a friction element for coupling to a desired shift range can be operated.

While generating the line pressure of the high-pressure part, the shift controller 21 determines the rotation speed of the pump motor 31 from a map defined on the basis of temperature and durability of oil and compensates for the rotation speed of the pump motor 31.

The shift controller 21 maintains the line pressure in the high-pressure part in the optimum state by controlling the rotation speed of the pump motor 31 and a regulator valve in accordance with line pressure generated after the hydraulic pressure detector 13 detects the line pressure generated in the high-pressure part.

The pump motor 31 drives the low-pressure hydraulic pump and the high-pressure hydraulic pump connected to a motor shaft, with the rotation speed controlled in response to a control signal from the shift controller 21.

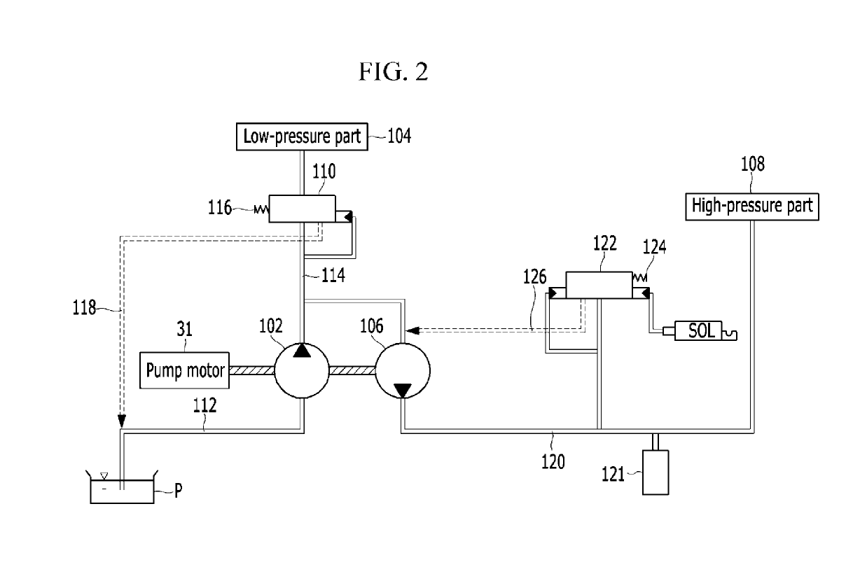

FIG. 2 is a schematic diagram of a hydraulic pressure supply system of an automatic transmission according to various embodiments of the present invention. Referring to FIG. 2, a hydraulic pressure supply system of an automatic transmission is configured such that the hydraulic pressure generated by the low-pressure hydraulic pump 102 is supplied to the low-pressure part 104 including a torque converter T/C to cool and lubricate them and the hydraulic pressure generated by the high-pressure hydraulic pump 106 is supplied to the high-pressure part 108 to operate the friction elements (on-coming elements and off-going elements) relating to shifting.

The hydraulic pressure from the low-pressure hydraulic pump 102 is controlled at a low level enough for smooth operation, cooling, and lubrication of the torque converter T/C and the hydraulic pressure from the high-pressure hydraulic pump 108 is controlled at a high level enough to smoothly operate a plurality of friction elements (on-coming elements and off-going elements) selectively operated in shifting.

The low-pressure hydraulic pump 102 and the high-pressure hydraulic pump 106 are connected to the rotary shaft of the pump motor 31 and driven by the pump motor 31 under the control of the shift controller 21.

The low-pressure hydraulic pump 102 sucks the oil in an oil pan P through an intake channel 112 and discharges it to a low-pressure channel 114 and the hydraulic pressure from the low-temperature hydraulic pump 102 is controlled to be stable through a low-pressure regulator valve 110 and supplied to the low-pressure part 104.

The low-pressure regulator valve 110 controls the hydraulic pressure of the low-pressure part 104 by recirculating some of the hydraulic pressure, which is supplied through the low-pressure channel 114, through a first recirculation channel 118 while being controlled by the elastic force of an elastic member 116 and the hydraulic pressure in the low-pressure channel 114, which are exerted at opposite sides.

The high-pressure hydraulic pump 106 increases and discharges the hydraulic pressure supplied from the low-pressure hydraulic pump 102 and the hydraulic pressure in a high-pressure channel 120 is controlled and supplied to the high-pressure part 108 by a high-pressure regulator valve 122.

The high-pressure regulator valve 120 controls the hydraulic pressure at the high-pressure part 108 by recirculating some of the hydraulic pressure from the high-pressure channel 120 to the oil pan P through a second recirculation channel 126 while being controlled by the control pressure of a solenoid valve SOL and the elastic force of the elastic member 124 which are supplied to one side and the hydraulic pressure in the high-pressure channel 120 which is supplied to the other side.

The hydraulic pressure from the high-pressure hydraulic pump 106 is detected by a hydraulic pressure sensor S disposed at a predetermined position in the high-pressure channel 120 and then supplied to the shift controller 21 such that the rotation speed of the pump motor 31 can be controlled.

The operation of the present invention having the configuration described above is as follows.

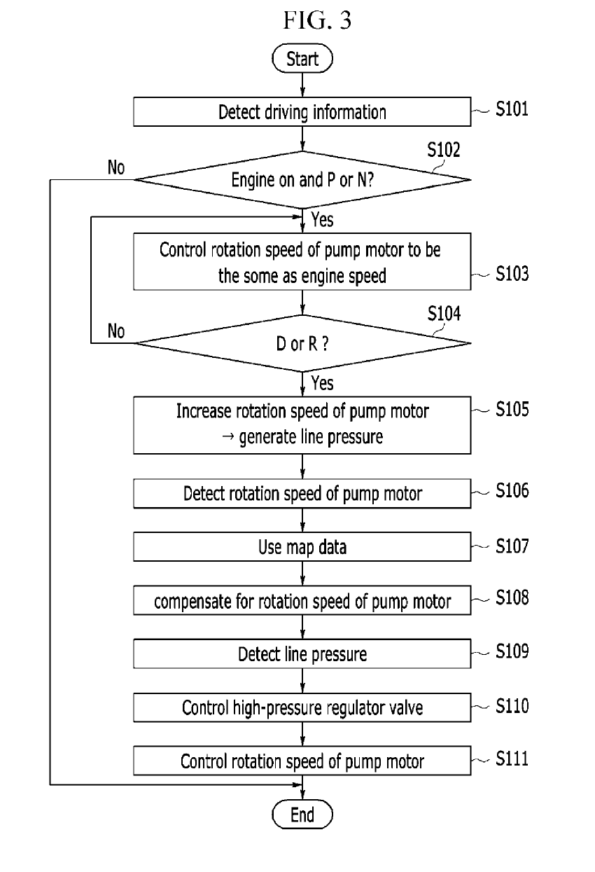

FIG. 3 is a flowchart illustrating a process of controlling a pump motor control for an automatic transmission according to various embodiments of the present invention. Referring to FIG. 3, as an automatic transmission vehicle where the present invention is applied is driven, the shift controller 21 detects the general driving information including whether the engine is turned on, the engine speed, the shift range selected by the shift lever, the hydraulic pressure in the high-pressure channel 120, and the rotation speed of the pump motor 31 (S101).

The shift controller 21 determines whether the engine has been turned on and the shift lever has selected the P range or the N range, by analyzing the information detected in step S101 (S102). When determining that the engine has been turned on and the P range or the N range has been selected in step S102, the shift controller 21 controls the rotation speed of the pump motor 31 to be the same as the engine speed (S103).

With the rotation speed of the pump motor 21 controlled to be the same as the engine speed, the shift controller 21 detects whether the shift lever is moved to the D range or R range (S104). When detecting the movement to the D range or R made in S104, the shift controller 21 generates line pressure in the high-pressure part 108 by increasing the hydraulic pressure from the high-pressure hydraulic pump 106 (S105).

Accordingly, the friction elements (on-coming elements and off-going elements) for coupling the shift ranges can be smoothly operated.

While the line pressure is generated in the high-pressure part 108 by increasing the rotation speed of the pump motor 31, the rotation speed of the pump motor 31 is feed-back detected (S106) and the rotation speed of the pump motor 31 is determined from the map set in accordance with the oil temperature and durability (S107), thereby compensating for the rotation speed of the pump motor 31 (S108).

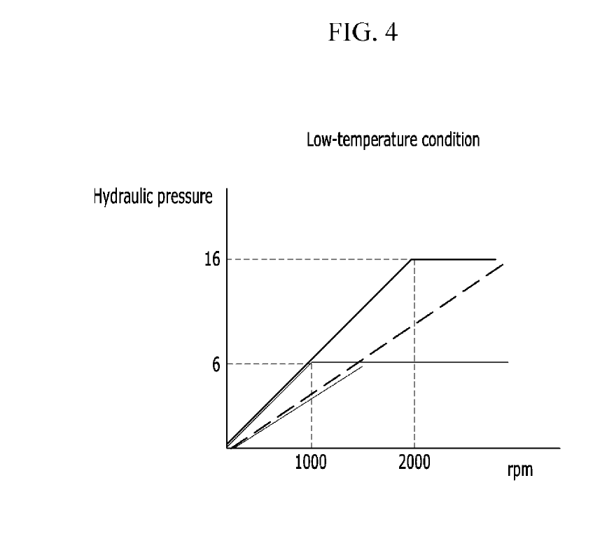

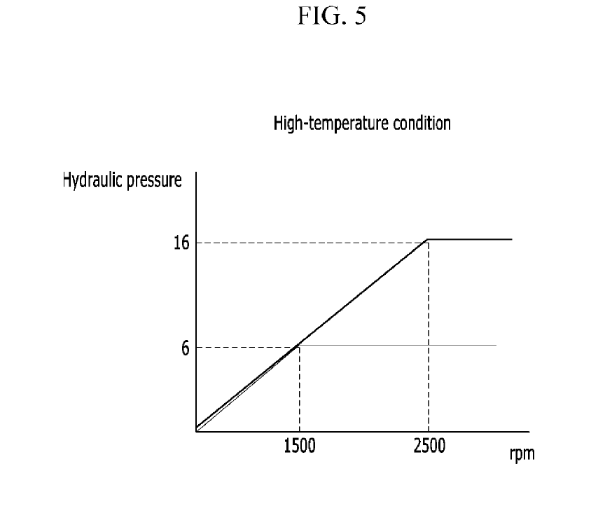

The compensation of the rotation speed of the pump motor 31 is controlled, for example, at 1000 RPM to generate hydraulic pressure of 6 bar and at 2000 RPM to generate hydraulic pressure of 16 bar, under a low-temperature condition, as shown in FIG. 4. Further, as shown in FIG. 5, it is controlled at 1500 RPM to generated pressure of 6 bar and at 2500 RPM to generate pressure of 16 bar under a high-temperature condition.

Further, the shift controller 21 detects the line pressure generated at the high-pressure part 108 by means of the hydraulic pressure detector 13 at a predetermined position in the high-pressure channel 120 (S109), and then controls the high-pressure regulator valve 122 on the basis of the line pressure (S110) and simultaneously controls the rotation speed of the pump motor 31 so that the pressure at the high-pressure part can be maintained in the optimum state (S111).

Only the operation of controlling the pressure for the high-pressure part is described above. The control of pressure at the low-pressure part is performed in a similar or common way by operating the low-pressure regulator valve, and thus the detailed description is not provided.

According to various embodiments of the present invention, in an oil supply system of an automatic transmission having the structure in which two hydraulic pumps are connected to one pump motor shaft, it is possible to control the rotation of the pump motors in the optimum state in accordance with the discharge pressure of the high-pressure part, such that stability and reliability in generating hydraulic pressure at the low-pressure part and the high-pressure part can be provided.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A pump motor control system for an automatic transmission, comprising:
a low-pressure hydraulic pump supplying hydraulic pressure to a low-pressure part in the automatic transmission;
a high-pressure hydraulic pump supplying hydraulic pressure to a high-pressure part in the automatic transmission;
a pump motor connecting the low-pressure hydraulic pump and the high-pressure hydraulic pump to one shaft and driving the pumps;
a pump motor rotation speed detector detecting a rotation speed of the pump motor; and
a shift controller controlling operation of the automatic transmission, wherein the shift controller
controls the rotation speed of the pump motor to be the same as engine speed at the P range or the N range,
generates the hydraulic pressure at the high-pressure part by increasing the rotation speed of the pump motor when the D range or R range is selected, and
stabilizes the hydraulic pressure by controlling the rotation speed of the pump motor in accordance with the hydraulic pressure generated at the high-pressure part.

2. The system of claim 1, further comprising a hydraulic pressure sensor disposed in a hydraulic line of the high-pressure part and detecting the hydraulic pressure generated at the high-pressure part.

3. The system of claim 1, wherein the shift controller compensates for the rotation speed of the pump motor by using a map set in accordance with oil temperature and durability of the automatic transmission.

4. A pump motor control system for an automatic transmission, comprising:
a pump motor connecting on one shaft a low-pressure hydraulic pump supplying hydraulic pressure to a low-pressure part and a high-pressure hydraulic pump supplying hydraulic pressure to a high-pressure part in the automatic transmission, and driving the pumps;
a high-pressure regulator valve controlling the hydraulic pressure generated at the high-pressure part;
a low-pressure regulator valve controlling the hydraulic pressure generated at the low-pressure part;
a shift controller controlling the pump motor, the high-pressure regulator valve, and the low-pressure regulator valve; and
a pressure sensor disposed in a channel of the high-pressure part and detecting the hydraulic pressure generated at the high-pressure part,
wherein the shift controller keeps the hydraulic pressure of the high-pressure part stable by controlling a rotation speed of the pump motor in accordance with the hydraulic pressure at the high-pressure part detected by the pressure sensor.

5. The system of claim 4, wherein the shift controller controls the rotation speed of the pump motor to be the same as engine speed at the P range or the N range.

6. The system of claim 4, wherein the shift controller compensates for the rotation speed of the pump motor in accordance with an oil temperature condition and durability of the automatic transmission.

7. The system of claim 4, wherein the high-pressure regulator valve is controlled by control pressure of a solenoid valve and an elastic force of an elastic member, and the high-pressure regulator valve controls hydraulic pressure of a high-pressure channel.

8. The system of claim 4, wherein the low-pressure regulator valve controls hydraulic pressure of a low-pressure channel by recirculating hydraulic pressure in accordance with an elastic force of an elastic member and the hydraulic pressure of the low-pressure channel, which are exerted at opposite sides of the low-pressure regulator valve.

9. A pump motor control method for an automatic transmission having a low-pressure hydraulic pump and a high-pressure hydraulic pump on one shaft of a pump motor, the method comprising:
detecting information including engine speed, a shift range selected by a shift lever, a rotation speed of the pump motor, and hydraulic pressure in a high-pressure part;
controlling the rotation speed of the pump motor to be the same as the engine speed, when engine is turned on and the P range or the N range is selected by the shift lever;
generating hydraulic pressure for operating a friction element in the high-pressure part by increasing the rotation speed of the pump motor, when the shift lever is moved to the D range or R range; and
keeping the hydraulic pressure at the high-pressure part stable, by controlling the rotation speed of the pump motor in accordance with the hydraulic pressure in the high-pressure part.

10. The method of claim 9, wherein the rotation speed of the pump motor generating line pressure at the high-pressure part is corrected in accordance with an oil temperature condition and durability of the automatic transmission.
